(19) United States
(12) Patent Application Publication
(10) Pub. No.: US 2009/0113772 A1
(43) Pub. Date: May 7, 2009

(54) VISUAL ELEMENTS ARRAY INFORMATION DISPLAY AND ROAD SAFETY SYSTEM

(76) Inventor: Arie Traupianski, Hod-Hasharon (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 11/577,148

(22) PCT Filed: Oct. 11, 2005
(86) PCT No.: PCT/IL2005/001084

§ 371 Date: Apr. 12, 2007

(51) Int. Cl. G09F 19/14; G09F 15/00; G09F 13/00; E01F 9/00; E01F 8/00; G08G 1/01; G01P 11/02; G10K 11/00

(52) U.S. Cl. 40/446; 40/584; 40/606.01; 40/607.13; 40/541; 404/9; 340/933; 73/488; 181/175

(57) ABSTRACT

The present invention discloses a system and method of displaying visual information, comprising a plurality of visual elements placed on a plurality of display modules, which are positioned so as to be cognitively perceived as forming an integrated, unified visual informational message, and that utilizes the principles of geometric perspective or of optical illusions to create interesting and effective messages, and that may incorporate other visual effects, to create a messaging system that is able to publicly convey commercial messages as well as road conditions and other information. Said devices may be applied to roadsides, as well as corridors, sidewalks, sides of buildings, bridges, aisles, and similar locations.

### FIELD OF THE INVENTION

The system of the present invention relates to devices for delivering messages in public access areas.

### BACKGROUND OF THE INVENTION

It is well known that the impact of outdoor and roadside advertising campaigns is enormous. Moreover, such outdoor advertisements are highly cost to effective in relation to other marketing media. However, in today's fast-paced, hi-tech world, there is an ever-increasing need for commercial messages to be cleverer, more eye catching, and more attention grabbing. Roadside ad campaigns need innovation in order to continue competing in this environment while maintaining the cost edge.

Additionally, drivers, especially those traveling in low visibility conditions, are at risk from several factors. If the road boundaries are not clearly identified, the driver may run off the road. When unpredictable conditions such as car accidents, flash floods, or debris in the road create emergency situations, the unaware and unwarned driver may crash into unforeseen obstacles or lose vehicle control. Low frequency, road induced noise and monotonous visual signals may bring on driver fatigue. There is a need for a system that will address the above-mentioned problems in order to enhance road safety.

Furthermore, road signs placed along the road can be annoying and mind numbing, obstructing the view of the surrounding land and failing to present a standard form of visual information to the drivers. There is therefore a need for a road signaling and informing system and method that will form an integral part of the road, be standard in appearance, and not obstruct the view.

Finally, where roadside buildings such as houses, offices or the like exist, occupants of these buildings are often disturbed by headlight beams shining through the windows of the buildings and by the noise produced by the passing traffic. Therefore, it is desirable that roadside mounted panels reduce the public's exposure to both road and traffic light and noise pollution.

### PRIOR ART

There are a number of prior art patents that provide methods of conveying messages to passengers that create the illusion of movement. For example, U.S. Pat. No. 17,677 and US Patent Application 2004/0027540 describe sequences of signs that appear to be moving. Both methods rely on vehicles moving past the signs at fixed speeds and from fixed distances to generate this effect. Other art requires that the message be viewed through filters or screens in order to create this illusion, as described in British Patent 106866 and European Patent 0065134

Additionally, there are presently in the art, patents for providing panels that reduce the glare from oncoming traffic, including U.S. Pat. Nos. 4,338,041, 5,022,781, and 5,181,695, and CZ Patent 2260818U, helping reduce some of the risk encountered by drivers but these do not address or minimize the other above-mentioned risk factors. For example, the repetitive nature of the said panels has a tendency to induce fatigue in drivers, which might result in the driver dozing off, and the visual obstruction of the scenery is a drawback by itself. There would therefore be a benefit to society if anti-glare systems will be further used to improve road markings, especially in bad visibility conditions and if said systems could further serve to convey efficiently current road information to the drivers.

Furthermore, there are roadside messaging systems, including PCT Application WO0186071, French Patent 000738484, and European Patent Application 000413877, that describe dividing a unified message into sections and distributing said sectioned message along the side of the road. It is intended that passers-by will view a clear and unified message. However, because of limitations in placement patterns and angles, as well as the sizes and shapes of the sections, the resulting message as perceived by the viewer may be distorted or unclear. Therefore, it would be useful if a system for displaying messages along a roadside, and other locations, provided a method for varying the shape, size, and placement of the displayed sections and additionally, allowed the contents of the sections to be distorted, in order to ensure that the viewer perceives a clear visual unified message

Financial considerations and the art of advertising, as well as temporary traffic situations, lead to further preferred systems that differ from prior art by allowing the contents of unified visual messages to be changed without requiring the replacement of the physical carrier modules on which the message sections are affixed.

### SUMMARY OF THE PRESENT INVENTION

The system of the present invention addresses the problems in a simple and straightforward manner by using a plurality of visual elements placed on a plurality of display modules that are positioned so as to form an integrated, visual, informational unified message that provides multiple benefits.

According to the invention, there is provided a visual device, comprising a plurality of visual elements placed on a plurality of display modules, which are positioned so as to form an integrated visual informational message, optionally combined with at least one signal light source, and incorporates visual effects to create an innovative roadside messaging system that is able to convey both commercial messages and current road condition information. Similar methods may further be applied in order to address pedestrians while they are walking in exterior and interior public passage ways such as streets, long corridors, sidewalks, past buildings, on bridges, on aisles and similar such locations.

The present invention discloses a system and method of displaying visual information that is formed from the cognitive integration of several modules, which serves to display large and clear messages, utilizing the principles of perspective or optical illusions to create interesting and effective messages. An additional benefit is to avoid invoking driver sub-conscious fatigue as may happen if small and repetitive visual cues are monotonously displayed or presented along the travel route.

In accordance with a preferred embodiment of the present invention, there is thus provided a system for displaying visual messages to be viewed from a designated viewing area. Said viewing area including at least one designated viewing point, and said system is comprised of at least two display modules of calculated size, positioned at calculated distances from each other and at calculated angles, in accordance with a predefined placement pattern. Each module carries at least one message section of calculated size and is a portion of a unified message, wherein the cognitive combination of the physical message sections creates the perception of a large and clear visual unified message when viewed from the designated viewing area.

According to some embodiments of the present invention, at least one of the following parameters has variable value: the modules size, message section size, the distance between the modules, or the module placement angles.

According to other embodiments of the present invention, the predetermined placing pattern is a straight placement line at a relative angle to the viewing area.

According to yet other embodiments of the present invention, the placement angle of at least several of physical message sections is constant.

According to yet other embodiments, the angles are defined by positioning the modules at approximately right vertical angles (90°) to the line of sight of onlookers positioned in a designated viewing area.

According to yet further embodiments of the present invention, the predefined placement pattern is designed so that when viewed from anywhere other than the designated viewing points, the modules cause minimal obstruction to viewing the surrounding scenery.

According to yet another embodiment, the modules are positioned along a curved placement line.

In some embodiments of the present invention, the size of at least several of physical message sections or of the modules is constant.

In some other embodiments of the present invention, the size of at least one module is designed to fit a full letter of text on a physical message section placed on the said module.

In yet other embodiments of the present invention, at least one physical message section or module is extended to include, in addition to its original part of the visual message, a repetition of a part of the visual message that appears on an adjacent module.

According to another preferred embodiment of the present invention, the modules are located behind each other at a relatively close distance and at least a portion of at least one module or physical message section is designed to be transparent so that the overlapping combination of the transparent physical message section with a visual element of another section creates the effect of one clear unified message when viewed from the designated viewing points.

According to yet other embodiments of the present invention, the geometric shape of the module or physical message section is not symmetric.

According to other embodiments of the present invention, the relative geometric proportions between the various parts of the module or physical message section are designed so that when viewed from a short distance, the unified message is perceived as being essentially straight and when viewed from a long distance, the unified message is perceived as being distorted.

According to yet other embodiments, the geometrical shape of the modules or physical message sections are designed so as to create a continuous circumferential shape for the unified message when viewed from the designated viewing area.

According to other embodiments, the display modules are mounted on the walls, floors, or ceilings of buildings, including interior and exterior spaces of a building.

According to yet other embodiments of the present invention, at least one message section or visual element on at least one module is of a different size, enabling the creation of perspective illusion.

According to yet another embodiment, the system of the present invention utilizes panels as display modules, wherein said panels, formed as shutter blades, are positioned and spaced apart end to end, along the length of a road.

According to yet other embodiments, said display modules are made of a material that absorbs light energy to eliminate glare.

According to yet other embodiments of the present invention, the physical message section enables the mechanical or manual changing of at least one visual element.

According to yet other embodiments of the present invention, the modules are formed so as to include a dynamic physical message section that can be altered electronically.

According to yet other embodiments of the present invention, the unified message conveys at least one of the following: road related information, or commercial information.

Some embodiments of the present invention have a mounting device for connecting the display modules to a road part at different angles.

Other embodiments of the present invention have at least one attachment device to enable attaching physical message sections to the display modules.

According to other embodiments of the present invention, at least one display module is equipped with at least one lighting element.

According to yet other embodiments, at least one display module is equipped with at least one sensor for measuring at least one road traffic parameter.

According to yet other embodiments of the present invention, at least module is equipped with at least one data transmission device that is able to transmit sensor measurements to bypassing vehicles or to a remote terminal.

According to yet other embodiments of the present invention, at least one display module has at least two faces, each module face addressing at least one direction.

According to yet other embodiments of the present invention, each module face displays a part of a different unified message.

According to yet other embodiments of the present invention, said display modules further include at least one pressure energy absorbing element for absorbing and reducing road noise.

According to yet other embodiments of the present invention, the lighting element is a passive device, selected from having a distinct color or from being energized by light from passing vehicles.

According to yet other embodiments of the present invention, there is a lighting element that is an active device, energized by a power source from natural energy sources.

According to yet other embodiments of the present invention, the relative distance between at least several adjacent physical message sections or modules is constant.

According to yet other embodiments of the present invention, the lighting element signals to the vehicle once the vehicle reaches a predefined proximity to a predefined location on the road.

According to yet other embodiments of the present invention, the lighting element may have distinct colors to advise the passing driver of road boundary types or road conditions or to denote the left and right sides of the road boundary to the passing driver.

According to yet other embodiments of the present invention, at least one visual element includes distinct colors to advise the passing driver of road boundary types or road conditions or to denote the left and right sides of the road boundary to the passing driver.

According to yet other embodiments of the present invention, at least two visual elements are present and vertically spaced, denoting to the passing driver the depth of the road covered by water or snow.

According to yet other embodiments of the present invention, at least one visual element is repeated over multiple modules in a pseudo-random manner.

According to yet other embodiments of the present invention, at least one visual element is repeated over multiple modules in a manner that creates the appearance of an animated unified message.

According to yet other embodiments of the present invention, individual modules can be electronically controlled to display, or hide, a visual element at a specific frequency in order to create the impression that the visual element is moving across the array at a specific speed.

Furthermore, in some embodiments of the present invention, said speed is a traffic related speed selected from the speed of at least one vehicle and the average speed of the traffic moving alongside the modules.

Some embodiments of the present invention include a sensor for measuring vehicle speed, wherein said speed is the speed of at least one vehicle moving alongside the modules.

According to other embodiments of the present invention, the distances and angles of the predetermined placement pattern of the display modules or physical message sections and their sizes are calculated in accordance with an algorithm based on mathematical formulae that define the geometric relationship between the designated viewing point locations and the placement of the display modules.

According to yet other embodiments of the present invention the display modules are designed to be at least partially made of flexible parts.

According to yet other embodiments of the present invention, the display module or physical message section is designed and constructed as a slender, elongate panel body.

According to yet other embodiments of the present invention, the display module or physical message section or visual element may be designed and constructed as a volumetric, three-dimensional body.

According to yet other embodiments of the present invention, the physical message section of the display module creates a three-dimensional visual effect.

According to yet other embodiments of the present invention, blinders attached to the sides of the display module so as to limit the range of viewing angles.

According to yet other embodiments of the present invention, a single visual element in the form of a subliminal message is inserted within an array of physical message sections.

According to yet other embodiments of the present invention, at least one visual element is distorted, and where the distortion is calculated in accordance with an algorithm based on mathematical formulas that define the differential perceived distortion created by the distortion of each part of the unified message.

Another preferred embodiment of the present invention discloses a method for displaying visual messages to be viewed from a designated viewing area. said viewing area including at least one designated viewing point, and said method comprising the step of positioning at least two display modules of variable size, at variable distances from each other and at variable angles, in accordance with a placement pattern, each module carrying at least one physical message section of a unified message, wherein the cognitive combination of the physical message sections creates the perception of a large and clear visual unified message when viewed from the designated viewing area.

Some embodiments of the present invention comprise the step of calculating the distances and angles of the predetermined placement pattern of modules or physical message sections and their sizes in accordance with an algorithm based on mathematical formulae that define the geometric relationship between the designated viewing point location and the placement of the visual elements of the unified message.

Other embodiments of the present invention comprise the step of dynamically moving or rotating at least one visual element.

Yet other embodiments of the present invention further comprise the step of dynamically changing the physical dimensions of the module or the message section or the visual element.

According to yet other embodiments of the present invention further comprise the step of dynamically changing the positioning of at least one module or message section or visual element.

### BRIEF DESCRIPTIONS OF THE DRAWINGS

These and further features and advantages of the invention will become more clearly understood in light of the ensuing description of a preferred embodiment thereof, given by way of example only, with reference to the accompanying drawings, wherein-

FIG. 1 describes the relationship of the various components that comprise the application.

FIG. 2 describes a typical elongate module, including several optional features.

FIG. 3 describes one possible configuration of a plurality of modules, wherein differing visual elements span the modules to create a unified message that is cognitively perceived as an image resembling a banana.

FIG. 4 describes another optional configuration of a plurality of modules, wherein a single visual element is displayed multiple times in pseudo-random frequency on a plurality of modules.

FIG. 5 describes a further optional configuration of a plurality of modules, wherein a single visual element is repeated and arranged in a way that creates an animation effect.

FIG. 6 describes three optional placements of a plurality of modules that form an array.

FIGS. 7-16 describe various alternative embodiments of the present invention and the relationships between the various elements that determine the required placement and size of the modules in order to produce the desired visual effect.

FIG. 17 describes an optional method of constructing a connection means where the message section slides in and out of a frame type connection means.

FIG. 18 describes an optional method of constructing a connection means where the width and height of the connection means are independently adjustable.

FIG. 19 describes an optional method of constructing a connection means where the message section travels up and down within the connection means.

FIG. 20 describes a typical three-dimensional module.

FIG. 21 describes a typical array of three-dimensional modules.

FIG. 22 describes a plan view of a typical city street, with a typical array of modules mounted on the outer wall of a building.

FIG. 23 describes a typical array of modules mounted on the outer wall of a building.

FIG. 24 describes a sectional and elevation view of an array of modules mounted on the ceiling of a long corridor in a building.

FIG. 25 describes a typical array of modules mounted on the ceiling of a long corridor in a building.

### DESCRIPTIONS OF SAMPLE PREFERRED EMBODIMENTS

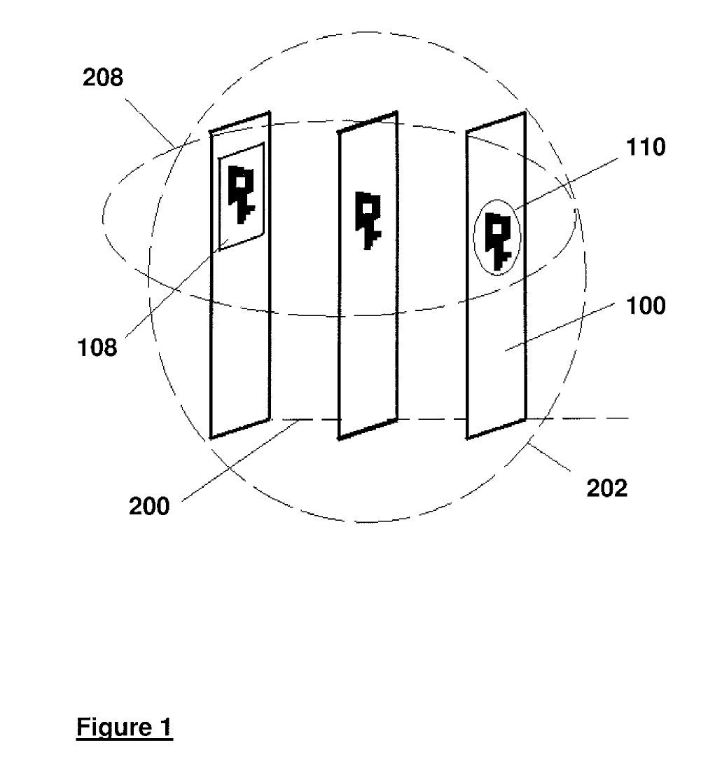

FIG. 1 demonstrates how the components that comprise this application interact to form a unified message 208, which may cognitively be conceived by an onlooker as a screen or an animated visual message. This is achieved by combining at least two modules 100 into a unified array 202. An array 202 can be defined as a plurality of modules 100 that are positioned according to a calculated placement pattern, such as being aligned along a presentation line 200, in order to create a single unified message 208, where presentation line 200 is any predetermined line along which modules 100 are aligned and unified message 208 is the complete message that runs across a full array 202. Unified message 208, that is, the overall message that is conveyed to the target audience, is sectioned into a plurality of physical message sections 108 that are mounted on a plurality of modules 100. Each physical message section 108 comprises a single or multiple visual elements 110 that act as the graphic contents imprinted or placed on the message sections.

When seen from a predetermined viewing area, array 202 is cognitively viewed as a unified message 208. The viewing area may be defined as at least one intended line of sight (LOS) 210 that originates from an onlooker point of view 212. Furthermore, an onlooker point of view 212 may be defined as the physical point at which the onlooker is situated, at any given moment, when viewing an array 202 or module 100 and a line of sight (LOS) 210 may be defined as the line of sight between the intended onlooker, when in a predetermined spot, and a module 100.

In the preferred embodiment, a system is provided that utilizes a plurality of modules 100, essentially formed as shutter blades, and essentially arranged as an array 202 by having modules 100 positioned and spaced apart end to end, along a presentation line 200 essentially parallel to the length of a highway median barrier. In other embodiments, the system provides a plurality of modules 100 placed similarly along a roadside, on a building side, passageway, corridor, aisle, or any other interior or exterior space that is large enough to accommodate the desired system size.

By placing modules 100 at variable distances from each other and at predetermined angles, the overall number of modules 100 required to achieve a unified message 208 can be reduced.

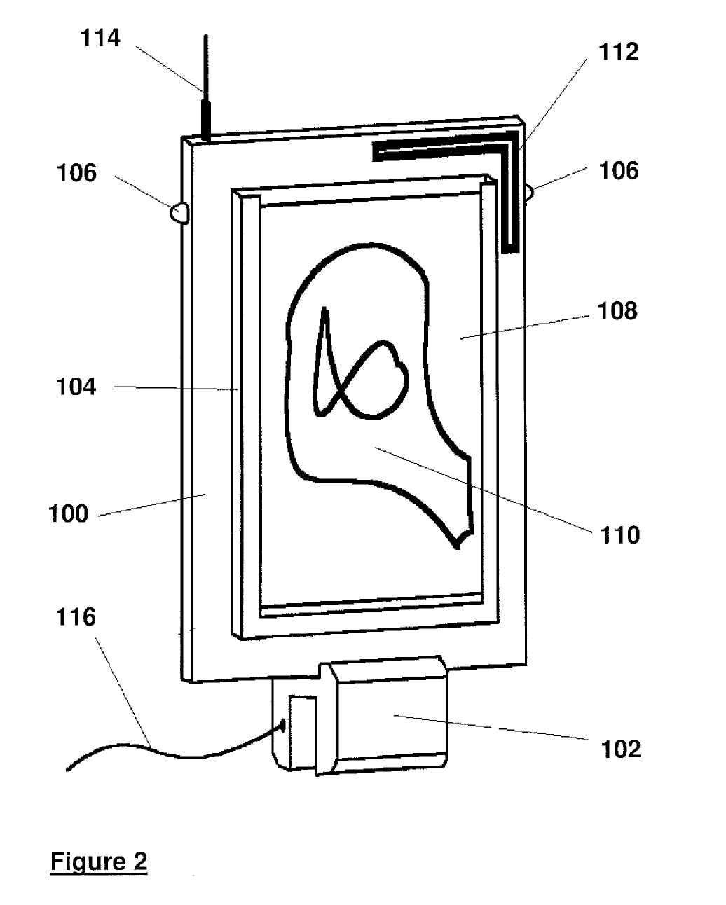

Turning now to FIG. 2, there are described the components of a single module 100 that constitutes the basic unit of the application. Module 100 is equipped with a base 102 that enables connection of module 100 to a road barrier, the ground, a wall, or other surface. Each module 100 is further equipped with a physical message section 108, which is mounted on module 100 by a connection means 104 including, inter alia, a frame, screws, vacuum caps, rivets, magnets, adhesive, hooks, nails, pins, clips, or other means.

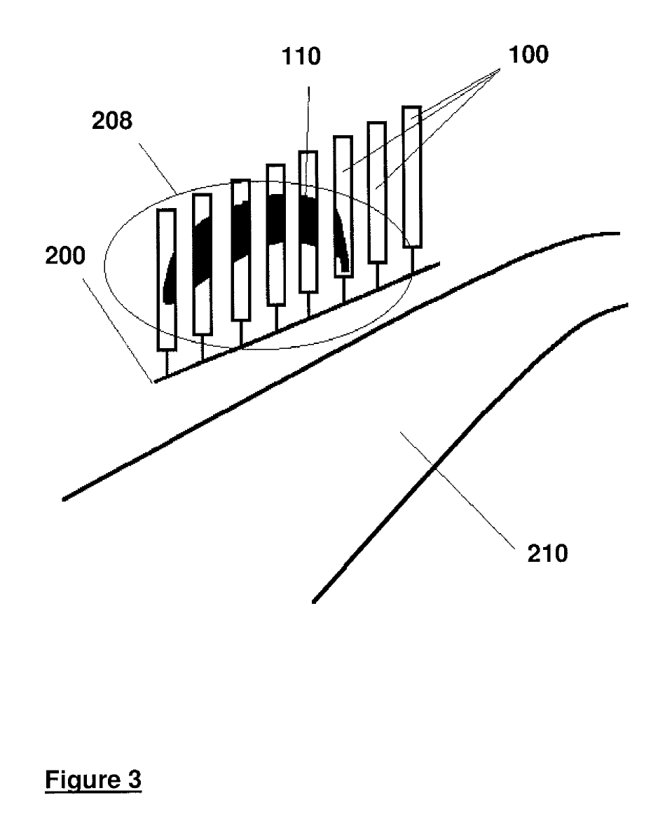

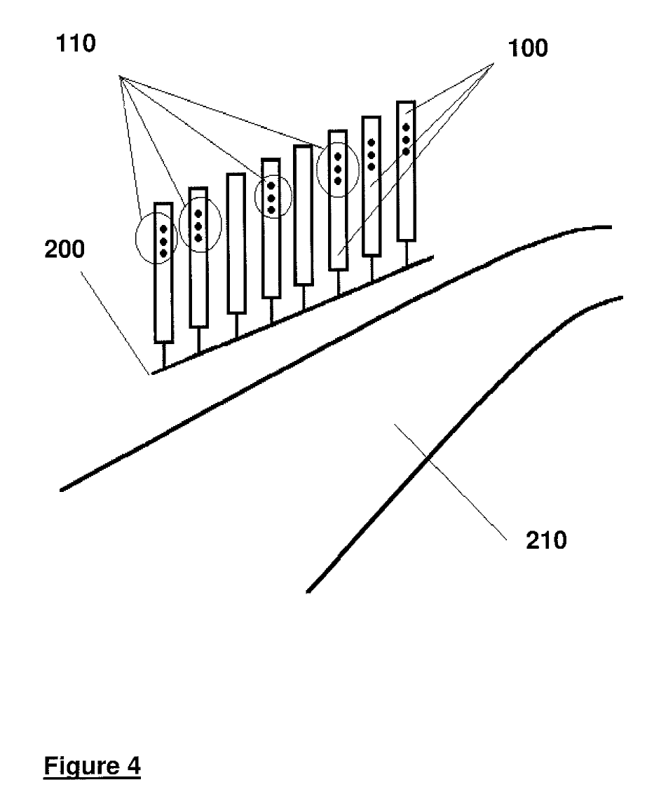

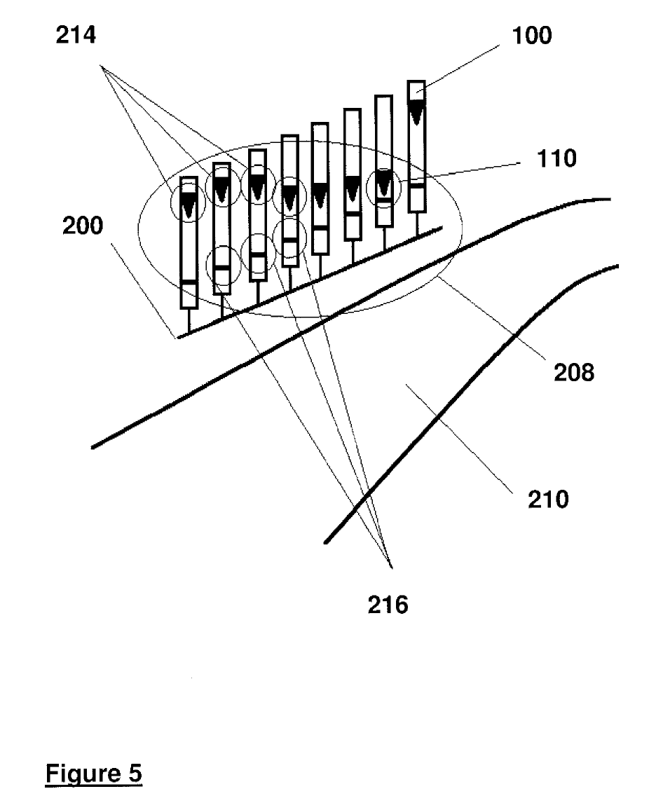

Physical message section 108 functions as the message area of individual module 100. Each physical message section 108 contains one or more visual elements 110. Visual element 110 is a single portion or element of a complete or unified message 208. When arranged in array 202, an onlooker's cognitive integration of said visual elements 110 creates the illusion of a larger unified image as seen in FIGS. 3, 23 and 25, or a pseudo-randomly repeated message as seen in FIG. 4, or an animated message as seen in FIG. 5.

Optional components such as lighting elements 106, sensor devices 112, communication devices 114, including antennas, and wires or cables 116 may also be mounted on module 100

Shown in FIG. 2 is a panel type module 100. Module 100 according to this embodiment is further equipped with a connection means 104 such as a frame. Said connection means 104 enables physical message section 108, carrying at least one visual element 110 such as a painted surface, a printed foil, or a display screen, to be attached to module 100.

According to at least one preferred embodiment, said module 100 is further equipped with at least one marking element 206 that assists in driver orientation by denoting the road boundaries or a road condition.

According to one embodiment of the present invention, physical message sections 108 of modules 100 may be changed or altered by means of manual, mechanical, or electronic means.

According to another preferred embodiment, modules 100 are formed so as to include a dynamic physical message section 108 that can be electronically altered such as when utilizing an LCD (Liquid Crystal) display, an OEL (Organic Electro Luminescence) display, Electronic Paper, or materials such as display fabric or tissues. This dynamic feature may be used to alter or change said visual element 110 that is displayed by modules 100.

According to at least one preferred embodiment, module 100 features a sensor device 112 that may be, inter alia, a Passive Infra Red (PIR), Microwave (MW), ultrasound, magnetic hall effect, impact piezo-electric, or similar sensor. Said sensor device 112 may be used to sense the proximity of a passing vehicle or person to a module 100, a sign, or barrier, and initiate an action such as alerting the driver if he is too close to the boundary, using RF (Radio Frequency) transmission via a communication device 114 to signal the car or visually signaling the driver by blinking lighting element 106 or changing the color of lighting element 106 or both. Additionally, audio signals or visual signals or both may be used to focus the attention of pedestrians.

Alternatively, a reverse-reporting sensor device 112 may be used to measure traffic parameters such as number of vehicles, average speeds, noise etc, and transmit them by RF via a communication device 114 or by wires or cables 116 to remote traffic monitoring and control centers.

Module 100 and the systems on it may be powered by a battery located in base 102 or by roadside power sources via wires or cables 116 or alternatively by solar power receivers or by Piezo-electric devices used to charge said batteries.

Module 100 and further devices on it may alternatively be passive devices powered by available energy sources such as vehicle headlights, noise, piezo-electric or similar sources.

Turning now to FIGS. 3, 4, and 5, there is described a plurality of modules 100, which are mounted on connecting means 104 and arranged along presentation line 200 to form an array 202. Said array 202 acts as a screen that may be installed on the side of a road or another fixed location. Visual elements 110 are used in various ways to convey unified messages 208 that are created from cognitively integrating visual elements 110.

In one preferred embodiment, unified message 208 is spanned over several modules 100 to create a relatively large area. In FIG. 3, there is described an array 202 that forms a virtual screen element. A typical carrier module 100 is used to display visual elements 110. When said visual elements 110 are cognitively integrated by the onlooker, a unified message 208 is created, as in the example of FIG. 3, where unified message 208 resembles a banana. The large area is firstly required in order to create a display that will fit the needs of advertisers, whether commercial, public, or governmental. The spanning of unified message 208 over several elements has another positive effect of dramatically reducing repetitiveness of visual signals, thus reducing the driver's potential fatigue.

According to another embodiment, said visual element 110 is repeated, at a frequency that has the appearance of random distribution on unified message 208. Said pseudo-random distribution helps to avoid creating a potentially monotonous repetition of visual data, thus creating a unified message 208 that is a cognitively interesting and aesthetically pleasing advertisement and that also reduces the risk of invoking driver fatigue. In FIG. 4, there is described an array 202 wherein visual elements 110 are repeated in a pseudo-random frequency over several modules 100, where said pseudo-random repetition frequency helps maintain interest in unified message 208 and thereby also avoids visual fatigue.

According to another embodiment, a visual element 110 is repeated or is switched ON and OFF at a frequency that corresponds to a certain speed of the passing traffic, such as the speed of a specific car or the average traffic speed. The formula for determining said frequency is F=V/D, wherein “F” represents frequency, “V” represents velocity, and “D” represents the displacement between two modules 100. Thus, visual element 110 may have the effect of signaling to the driver that his speed is or is not within an acceptable range. Such a feature may be further used to alert or to issue strong warnings to speeding drivers.

According to yet a further embodiment option, visual elements 110 that comprise unified message 208 are arranged and distributed on physical message sections 108 in a manner that has the illusion of an animated visual message. Said animation serves to enhance the effectiveness of conveying a visual message to onlookers such as passing drivers or pedestrians. The visual illusion of animation is achieved by placing a series of specifically sized modules 100 at predetermined distances from one another in an array 202, at a predetermined angle to and distance from the road. This embodiment similarly has an effect of avoiding a monotonous repetition of visual data.

In FIG. 5, there is described a plurality of modules 100 that form an array 202. In this example, visual elements 110 are repeated and arranged in a way that creates the optical effect of an animated unified message 208. The animation effect in this example is generated by using a progression of incremental visual changes between visual elements 110, wherein visual elements 110 are exposed to and then hidden from the driver as he proceeds along array 202, so as to act as frames in a movie. In this example there is described an arrow or triangle element 214 that is moving downwards towards a static stripe element 216, as if to signal a “slow-down” visual message to passing drivers.

Alternatively, said visual effects, as well as other effects, may be produced by alternating the angles at which modules 100 are positioned along presentation line 200, in order to, for example, alternately hide and reveal portions of physical message sections 108 or visual elements 110. Another alternative is to mechanically switch visual elements 110 ON and OFF or move visual elements 110.

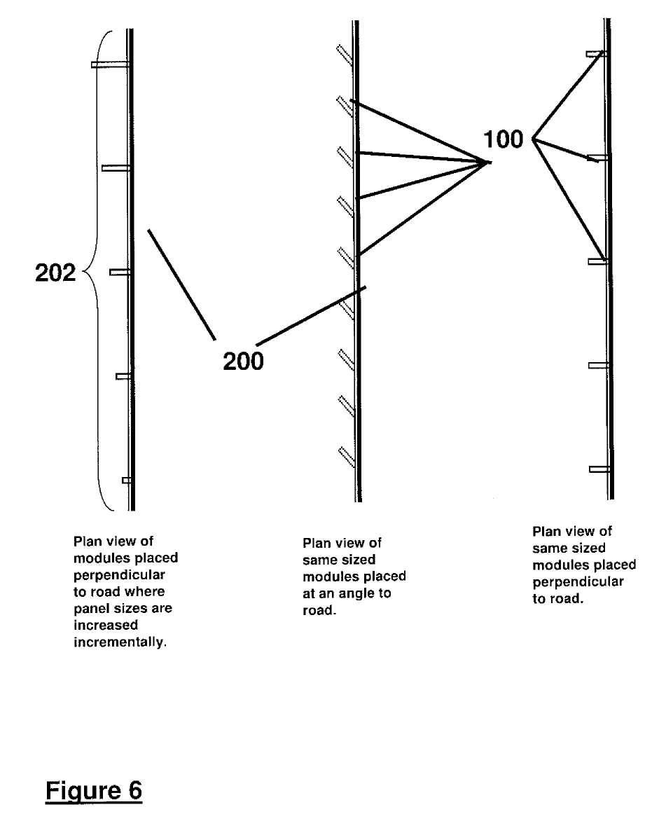

FIG. 6 demonstrates optional placements of a plurality of modules 100 that form an array 202. The leftmost example shows a bird's eye view of modules 100 placed essentially perpendicular to road where module 100 sizes increase incrementally. When seen from a distance, an array 202 in this configuration will appear as a single unit, creating the illusion of depth. The second example shows a bird's eye view of equal-sized modules 100 placed at an angle to the road. Placing modules 100 at an angle in relation to the road enables the creation of an optical illusion of movement as the driver approaches and then passes each module 100. In the example on the right, same-sized modules 100 are placed perpendicular to the road for yet other optical effects.

In order to further clarify and describe the present invention, descriptions of various embodiments are provided in greater detail, describing the approximate, typical geometric relationships of the various elements that determine the required placement and size of each module 100 in order to produce the desired visual effect that is to be created by array 202.

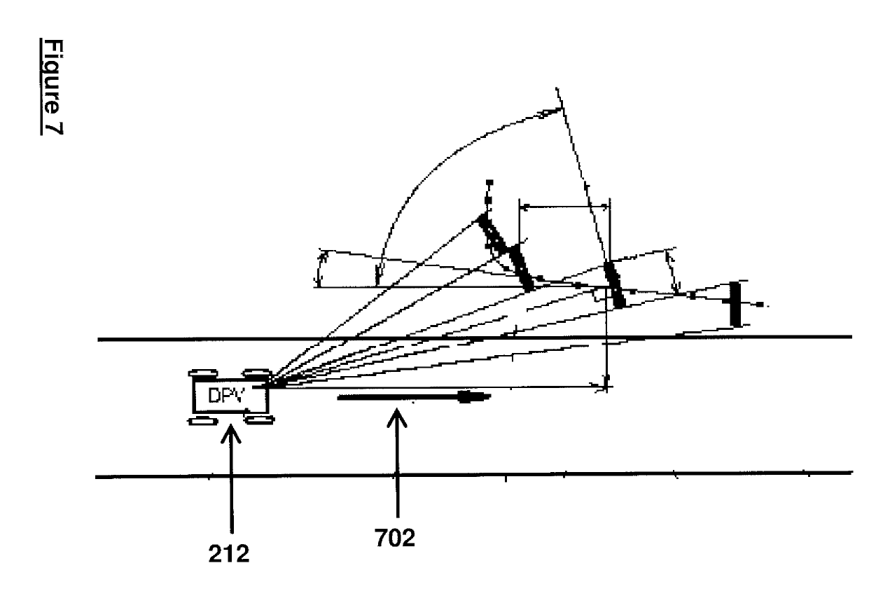

FIG. 7 describes a general case embodiment of the present invention, showing a bird's eye view of an evenly dispersed array 202 of perpendicular modules 100. For this type of embodiments, unified message 208 is created by cognitively integrating the perceived width of all physical message sections 108.

In FIG. 7, a vehicle is traveling along a road, and the direction of travel is indicated by arrow 702. The driver's eye is located at onlooker's point of view 212.

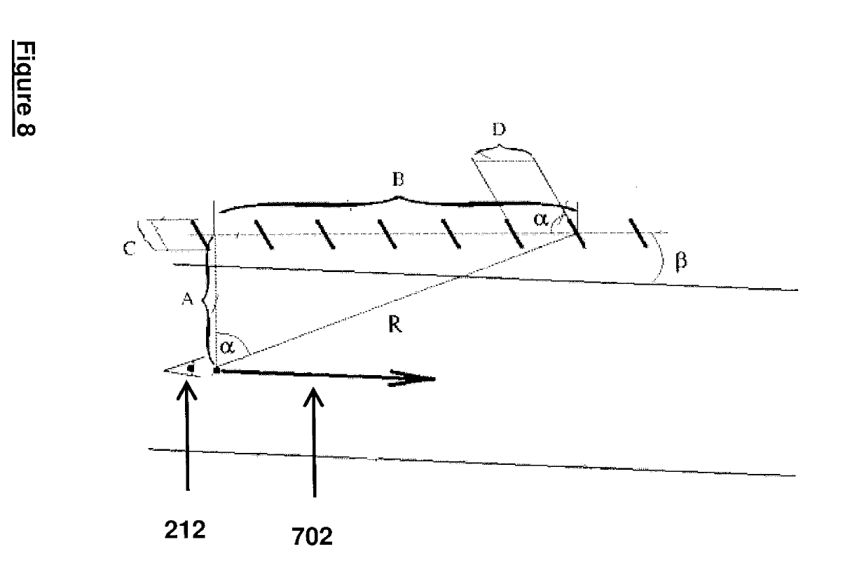

In FIG. 7, as well as FIGS. 8, 9, 10, 13 and 16, modules 100 are arranged along a curved presentation line 200, allowing the placement pattern of array 202 to accommodate a variety of small or confined spaces. For general case embodiments of the present invention, the following is true:
Di is the longitudinal displacement between two adjacent modules 100;
Ri is the range between the driver's eye and the N-th module 100, numbered by the index “i”;
Bi is the longitudinal vector component of Ri;
Ai is the transverse vector component of Ri;
Ci is a physical size, such as width or height, of N-th module 100 or of N-th physical message section 108;
Wᵢ is the perceived effective size of any of physical message sections 108;
α (alpha) denotes the adjustable rotation angle of the modules 100, also called the “aspect angle”, which may be defined as the deflection angle of a module 100, relative to the direction of travel of the onlooker, indicated by arrow 702;
β (beta) is the relative local angle created by presentation line 200 in relation to the direction of travel of the road; and
β (beta) may be positive or negative. Unified message 208 is created by WX, which is the effective integrated perceived size of all physical message sections 108 combined.

For general case embodiments of the present invention, the following equations apply:

$${α}_{i} ≅ {tan}^{- 1} \frac{{B}_{i}}{{A}_{i}} ≡ arctan \frac{{B}_{i}}{{A}_{i}} ; {C}_{i} ≅ {D}_{i} cos {α}_{i}$$

FIG. 8 describes another embodiment of the present invention, a Type “A” configuration, which is characterized by C; D; α; and β are constant

Type “A” embodiments are simple to install as the locations of modules 100 are spread evenly. At the same time, Type “A” embodiments may be complex to print, and are it is more practical to implement such embodiments in smaller spans of placement patterns.

Type “A” embodiments of the present invention have a straight presentation line 200, where β is constant.

For Type “A” embodiments of the present invention, the following equations apply:

The following equations apply:

$$α ≅ {tan}^{- 1} \frac{{B}_{i}}{{A}_{i}} ≡ arctan \frac{{B}_{i}}{{A}_{i}} ; {C}_{i} ≅ D cos α$$

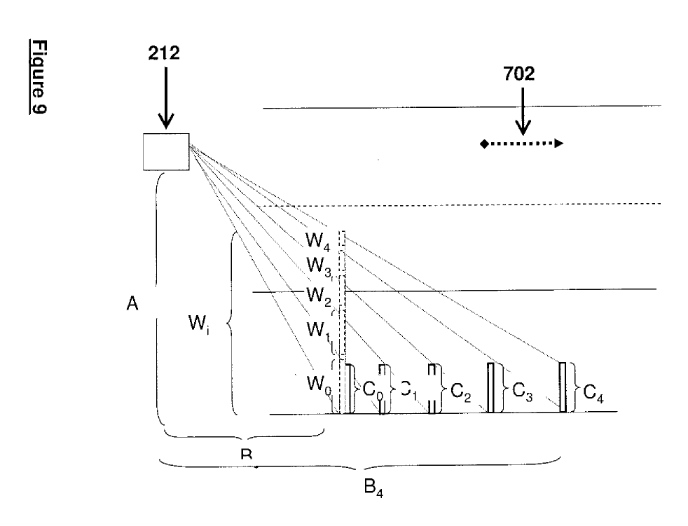

FIG. 9 describes yet another embodiment of the present invention, for a Type “B” array 202 that may be placed at variable displacements. Although this embodiment may be more complex to place, it is also easier to print.

The following statements are true for Type “B” arrays 202:
D is variable;
A, C and α (alpha) are constant; and
β (beta)=0°.

In FIG. 9, modules 100 are indexed as i (i=0 . . . 4).

In the example shown in FIG. 9, A is the constant lateral distance between the driver's onlooker point of view 212 and the line of inner edges of all modules 100.

The size C of module 100 is exemplified by the width in the current example. In this embodiment, Ci is the physical width of a physical message section 108.

Wᵢ is the perceived effective width of any of physical message sections 108.

Unified message 208 is created by WX, which is the effective integrated perceived width of all physical message sections 108 combined.

For Type “B” embodiments, modules 100 are positioned according to the algorithm described below.

Bᵢ must first be calculated. The distance B₀ of a first module 100 is set to a pre-selected desired distance to match the site conditions. The rest of modules 100 are positioned according to the following formula:

$${B}_{i} = \frac{{B}_{i - 1} \times ( {A}_{i} + {C}_{i} )}{{A}_{i}} = {B}_{i - 1} \times ( 1 + \frac{{C}_{i}}{{A}_{i}} )$$

An algorithm is then used to calculate Wᵢ, the effective perceived width of each physical message section 108. W₀ is the actual width of a first module 100 and therefore W₀=C.

The rest of physical message sections 108 appear to the onlooker as being sized according to the following formula:

$${W}_{i} = C \times \sqrt{\frac{{( {B}_{0} )}^{2} + {( A + \frac{C}{2} )}^{2}}{{( Bi )}^{2} + {( A + \frac{C}{2} )}^{2}}} ; WX = {\sum }_{i = 0}^{N - 1} Wi ,$$

where N is the number of modules 100.

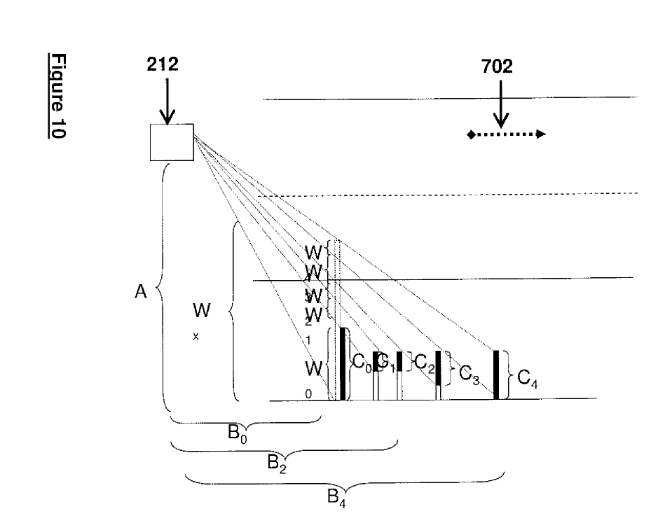

FIG. 10 describes yet another embodiment of the present invention, Type “C”, wherein modules 100 are arranged in an overlapping method. The following statements are true for Type “C” embodiments:
C is variable, extended in size over the minimal required size, partly repeating the adjacent physical message section 108 content;
D is variable;
A is constant;
A=90°; and
β (beta)=0°.

This embodiment is especially beneficial for text and for constant size visual elements 110, because there is one full visual element 110 per physical message section 108. Another feature of such an embodiment is that wider angles allow for a longer integrating time interval. Modules 100 of Type “C” embodiments may incur a relatively lower cost to produce and install due to their simplicity. Furthermore, Type “C” embodiments are suitable for limited length sites.

The algorithm used for this embodiment creates a visual effect wherein each physical message section 108, except the first one, appears to have an identical width when measured at the longitudinal position of first module 100.

This effect is achieved by “hiding” the undesirable part of each physical message section 108 with the preceding physical message section 108.

Thus, a layout of a uniform physical message section 108 width is created.

A typical situation at any given moment in time is described as follows:

In FIG. 10, modules 100 are indexed as i (i=0 . . . 4).

In this embodiment, the size Ci is the physical width of a physical message section 108.

Ti is defined for the purpose of the calculation as the temporal proportional module 100 width.

Wi is the perceived effective width of any physical message section 108.

Unified message 208 is created by WX, which is the effective integrated perceived width of all physical message sections 108 combined.

The longitudinal displacement Di between two adjacent modules 100 in the example shown in FIG. 10 may be calculated by

D_{N}=B_{N}−B_{N-1}.

The algorithm used to calculate Bᵢ and Tᵢ in determining the positioning of module 100 is described below.

A module 100, marked by the index N, is set in place. The longitudinal distance from the driver's onlooker point of view 212 for this module 100 is B_{N}. The width of Nth module 100 for this calculation is C_{N}. The calculation starts from the last index.

$${B}_{i} = \frac{{B}_{i + 1} \times A}{A + {T}_{i + 1}} ; {T}_{i} = C \times \sqrt{\frac{{( {B}_{i} )}^{2} + {( A + \frac{C}{2} )}^{2}}{{( {B}_{N} )}^{2} + {( A + \frac{C}{2} )}^{2}}}$$

The algorithm used to calculate the effective perceived width of each module 100, that is, to determine the Wᵢ calculation, is described below.

W₀ is the actual width of first module 100 and therefore W₀=C.

The rest of modules 100 appear to the onlooker as being sized by the following formula:

$${W}_{i} = C \times \sqrt{\frac{{( {B}_{0} )}^{2} + {( A + \frac{C}{2} )}^{2}}{{( Bi )}^{2} + {( A + \frac{C}{2} )}^{2}}} , WX = {\sum }_{i = 0}^{N - 1} Wi ,$$

where N is the number of modules 100 and first module 100 is numbered N=0, and last module 100 is numbered N−1.

Yet another embodiment of the present invention is a Type “D” embodiment, which may rely on a “distorted form” method.

For portions of unified message 208, such as modules 100 of this method, message sections 108, or visual elements 110, or any combination of the three, the following is true:
the shapes are non rectangular; and
the classic rules of perspective are used to distort the rectangular form in order to achieve visual effects of unified message 208.

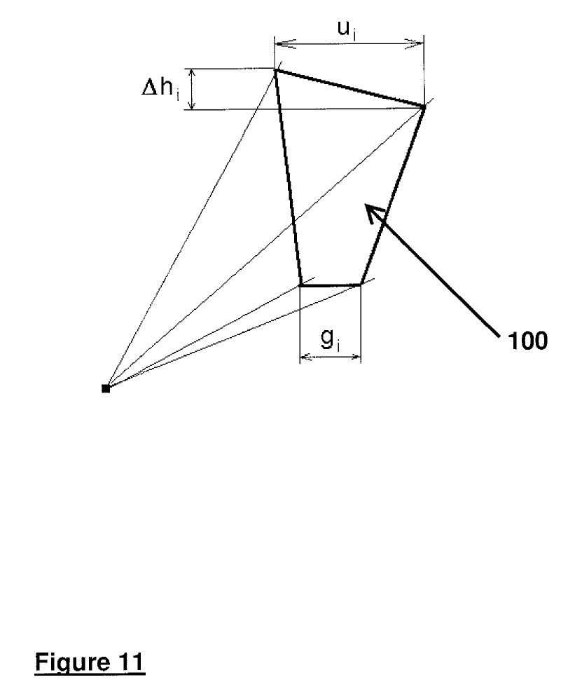

FIG. 11 describes a variation of a Type “D” embodiment of the present invention, referred hereto as a Type “Dt” Distorted Form system, wherein the following is true:
modules 100 are non rectangular; additionally, visual elements 110 are to be similarly distorted; and
unified image 208 seems to be rectified from very close range or from wide angled lines of sight (LOS) 210, but seems distorted from great distances or from narrow angled lines of sight (LOS) 210.

In this example, the height of the side of module 100 that is furthest from the onlooker is increased by a difference of Δh₁ relative to the height of the side that is closest to the onlooker.

The width gᵢ of the lower part of module 100 is smaller than the width uᵢ of the upper part.

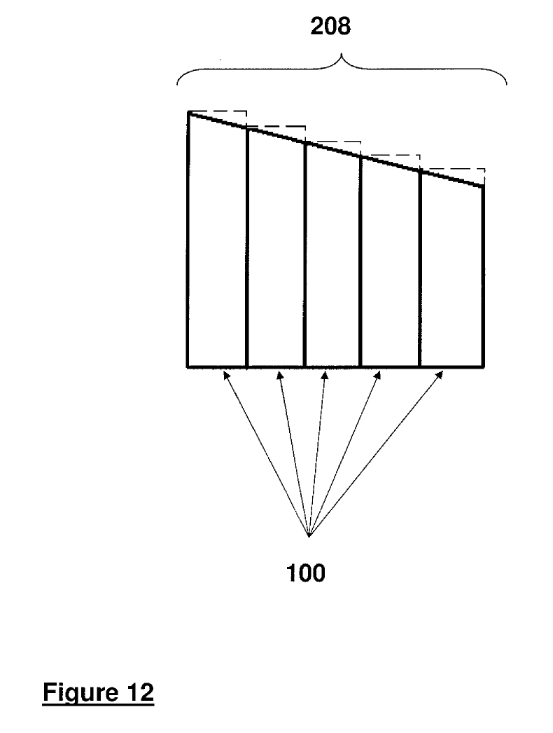

FIG. 12 describes another variation of a Type “D” Distorted form embodiment of the present invention, referred hereto as a Type “Da” Pointed Tip system, wherein the following is true:
modules 100 are non rectangular;
the upper parts of modules 100 are inclined so as to form a pointed tip;
a unified image 208 appears to have a continuous, non-staggered upper border; and
alternatively, if rectangular non-distorted modules 100 were to be used, the upper boundary of unified message 208 would appear as being staggered by the tips of the modules 100.

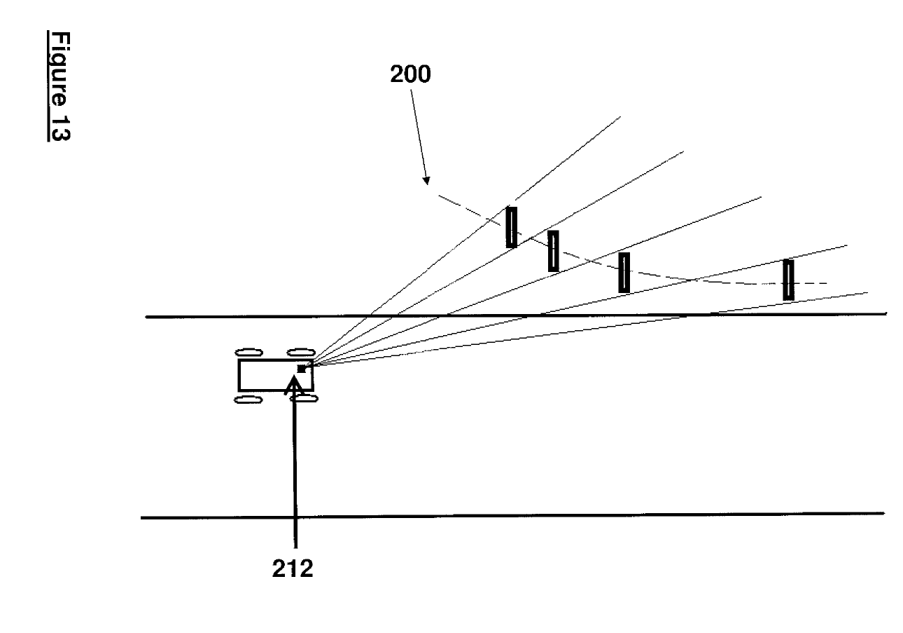

A Type “E” embodiment of the present invention is seen in FIG. 13, which is an example of a curvilinear presentation line 200 system.

For this embodiment, the following is true:
C=constant; and
Presentation line 200 is a curved line.

Such an embodiment has the added benefit of allowing the placement pattern of array 202 to be adapted to accommodate a variety of small or confined spaces as well as restrictive lines of sight (LOS) 210.

Yet another embodiment of the present invention is a Type “F” or “see-thru” array 202.

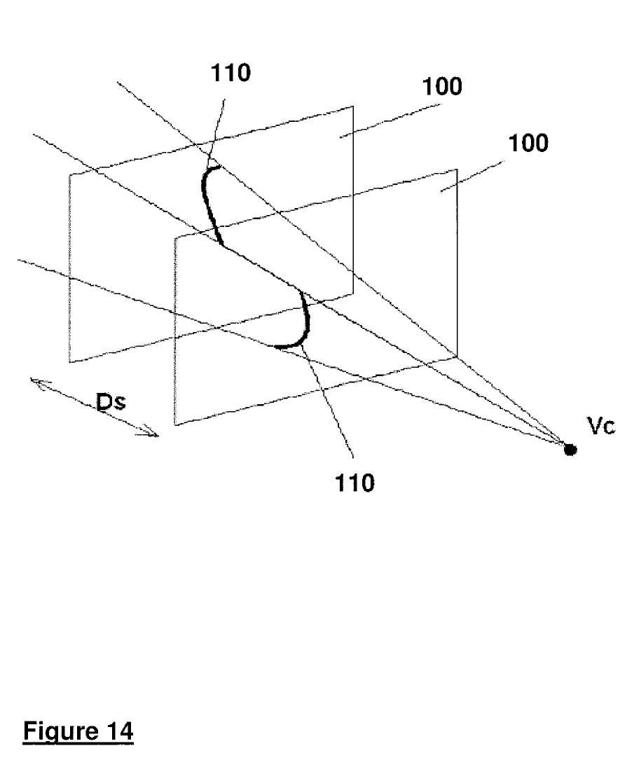

An example of such an embodiment can be seen in FIG. 14, wherein a unified message 208 is comprised from at least two visual elements 110.

Each of the two visual elements 110 is placed on a separate module 100; a first visual element 110 on a first module 100, and a second visual element 110 on a second module 100.

First and second modules 100 are placed on line of sight (LOS) 210 behind each other at a relatively close distance. The displacement Ds between the two modules 100 is short relative to the range Ri to the onlooker . . . .

At least part of first module 100 is transparent in the area of physical message section 108 or has at least one transparent visual element 110.

When looked upon from the vicinity of reference point Vc, both visual elements 110 will cognitively be integrated into a unified message 208 having the form of a slender “S” letter.

Deviating from line of sight (LOS) 210 of point Vc will result in a sharp loss of the ability of the viewer to cognitively integrate both visual elements 110.

This visual messaging method and system of a Type “F” embodiment may be useful for creating signs that may only be seen from a limited angle, thus having the advantage of avoiding confusion by onlookers from other angles, such as in a typical case of complex highway crossings, or in a typical case of airfield runways, especially those used for taxiing on the ground.

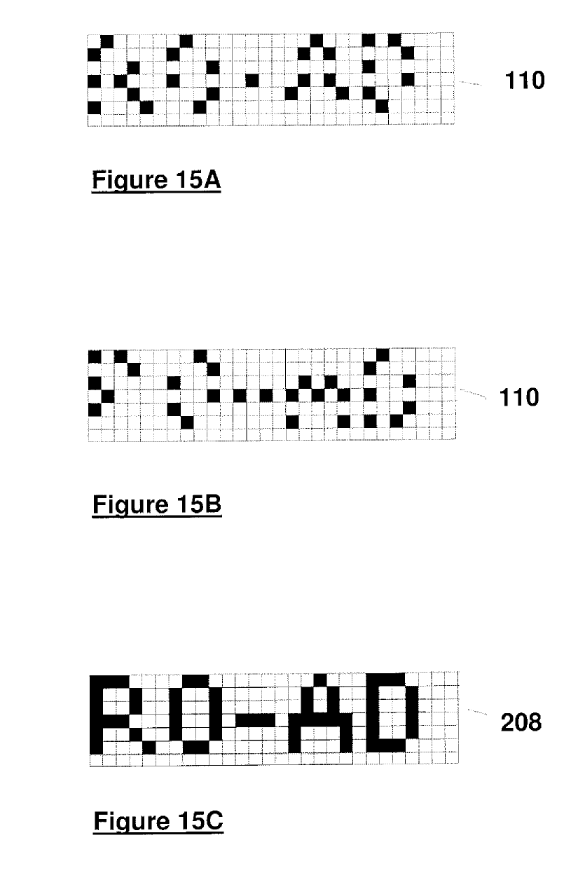

FIGS. 15A, B, and C show a typical embodiment of a Type “F” where the integration of two seemingly meaningless transparent modules 100 will result in a display of the contents of unified message 208 that contains the text: “RO-AD”.

FIG. 15A shows a visual element 110 that is to be placed on a first module 100, which is positioned relatively closer to the onlooker. First module 100 is constructed so as to be of a transparent background, at least in the area of physical message section 108. When seen alone, this visual element 110 seems meaningless. Next is a meaningless visual element 110, shown in FIG. 15B, to be placed on a second module 100 located on line of sight (LOS) 210 relatively farther from the onlooker. When looked upon from an essentially forward direction, visual elements 110 will be cognitively integrated into a unified message 208 that reads “RO-AD”, as shown in FIG. 15C. When looked upon from oblique directions, unified message 208 will not be perceived by the onlooker. This feature may be best used to avoid displaying information that may be perplexing to onlookers at different angular sectors.

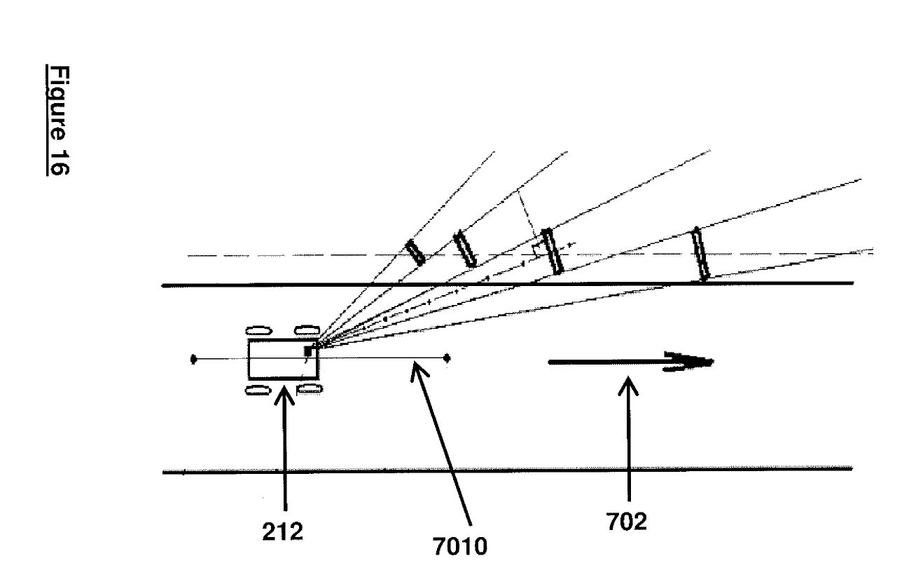

Still another embodiment of the present invention is a Type “G” embodiment, wherein α (alpha) varies for each module 100. An example of this embodiment may be seen in FIG. 16.

Each module 100 of a Type “G” embodiment is positioned roughly perpendicular to the line of sight (LOS) 210. Rotation angle αᵢ of each module 100 is set such that the relative angle of module 100 to line of sight (LOS) 210 is roughly a 90° right angle.

The calculations for this embodiment may be optimized by considering the effective viewing range 7010 for which line of sight (LOS) 210 will be optimized. The start point of viewing range 7010 is a first onlooker point of view 212 and the end of viewing range 7010 is a second onlooker point of view 212. In one possible embodiment, for example, the calculations will be made for a first onlooker point of to view 212 and then for a second onlooker point of view 212, wherein modules 100 may be finally placed and rotated according to the mean values derived from both onlooker points of view 212.

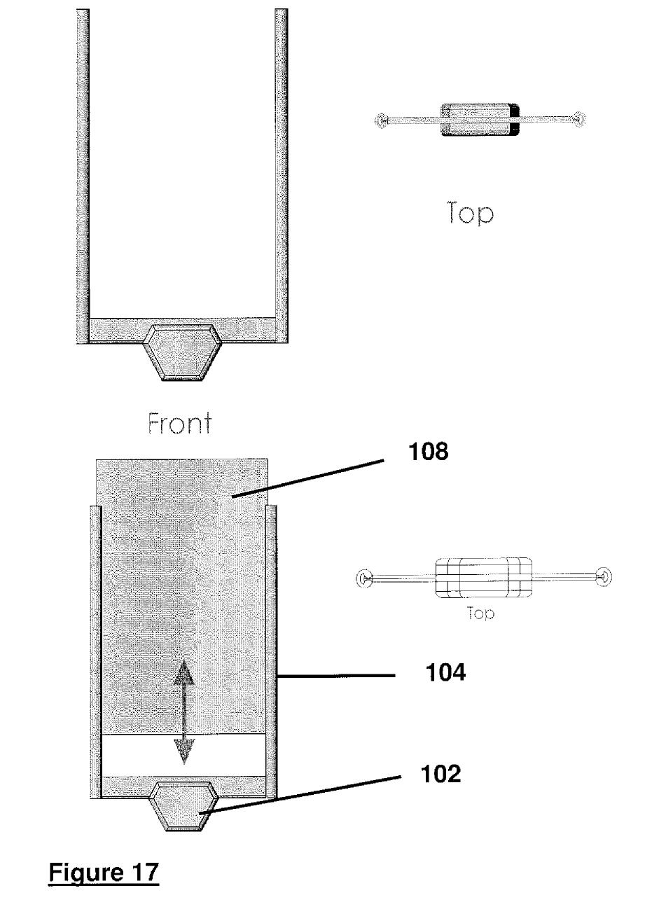

Physical message section 108 can be connected to modules 100 using any available attachment means that allows physical message section 108 to be attached securely to modules 100. FIGS. 2, 17, 18, and 19 describe several sample optional methods of constructing a connection means 104 for holding physical message section 108. In each figure, a connection means 104 for holding a screen-type physical message section 108 is mounted on a base 102. FIG. 17 shows a frame type connection means 104 wherein physical message section 108 is inserted into connection means 104 by aligning the vertical edges of physical message section 108 with corresponding channels along the vertical edges of connection means 104 and then sliding physical message section 108 into or out of connection means 104 as required.

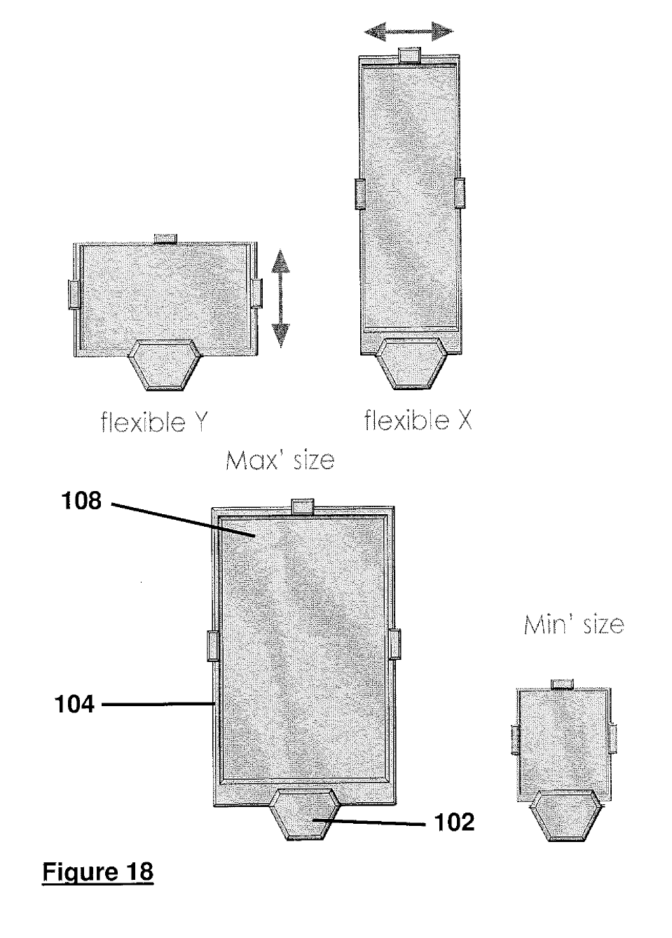

FIG. 18 describes a connection means 104 where the width and height of connection means 104, in the form of a frame, is adjustable independently, in order to accommodate screen-type physical message sections 108 of various sizes or of flexible stretchable material.

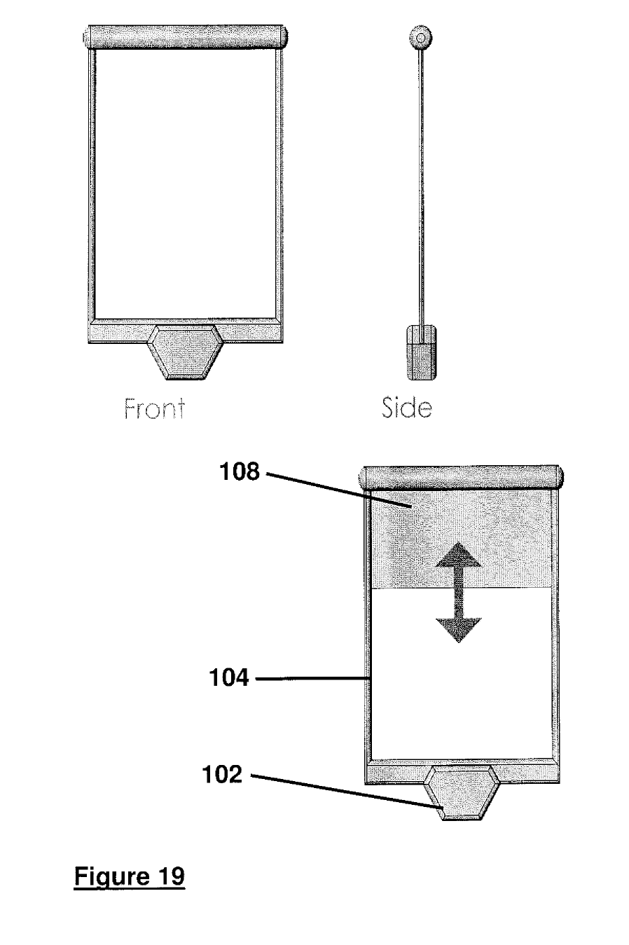

FIG. 19 describes another connection means 104 where a movable physical message section 108 is stored within a pocket located on the upper section of connection means 104 and can travel up and down along racks on connection means 104.

In another embodiment, physical message section 108 or module 100 may be a three-dimensional curved, thin surface of a volumetric body such as a balloon-like body, where an envelope or a sleeve is filled with, inter alia, air, gas, foam, or solid material.

Additionally, module 100 may be mounted on base 102 such that the relative orientation or aspect angle of module 100 in relation to base 102 is adjustable or dynamically variable by an actuating means such as an electric motor with a motion generating gear device. One example of such a mounting method is a bearing that allows a swiveling motion; another such example is a ball joint that allows vertical and horizontal motion. Other mounting methods that enable a varied adjustability may also be utilized.

There is also the option of non-electric, vertical modules 100 that rotate at a predetermined rate where each rotation may convey a series of different messages or variations of a single message. The positioning of such a module 100 may be dynamically rotated in time by means of a mechanism, or manually, or by the wind.

When three-dimensional type installations according to the present invention are set-up, multiple lines of sight (LOS) 210 are possible by dividing the circumference of each module 100 into multiple sectors, wherein each sector is intended to be viewed from a different direction.

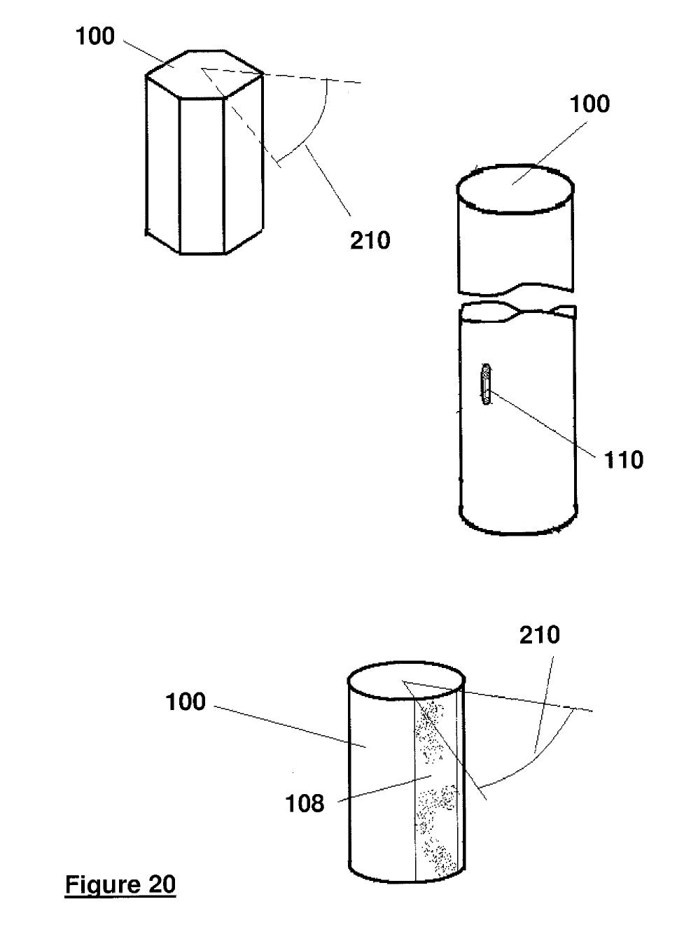

FIG. 20 describes a module 100 that is of a three-dimensional volumetric configuration. The example described herein may be a module 100 whose body is of a cylindrical shape or a module 100 whose body is multi-faced. Physical message section 108 containing visual element 110, as well as visual element 110 itself, may be two- or three-dimensional objects. The volumetric nature of these modules 100 makes it possible to use them for multiple viewing angles, wherein each line of sight (LOS) 210 is defined as belonging to a specific viewing sector. The plurality of sectors may be watched by various onlookers simultaneously from various directions and is very conducive to displaying multiple unified messages 208.

It is also possible to virtually create three-dimensional visual effects by the use of holograms and other such devices and techniques.

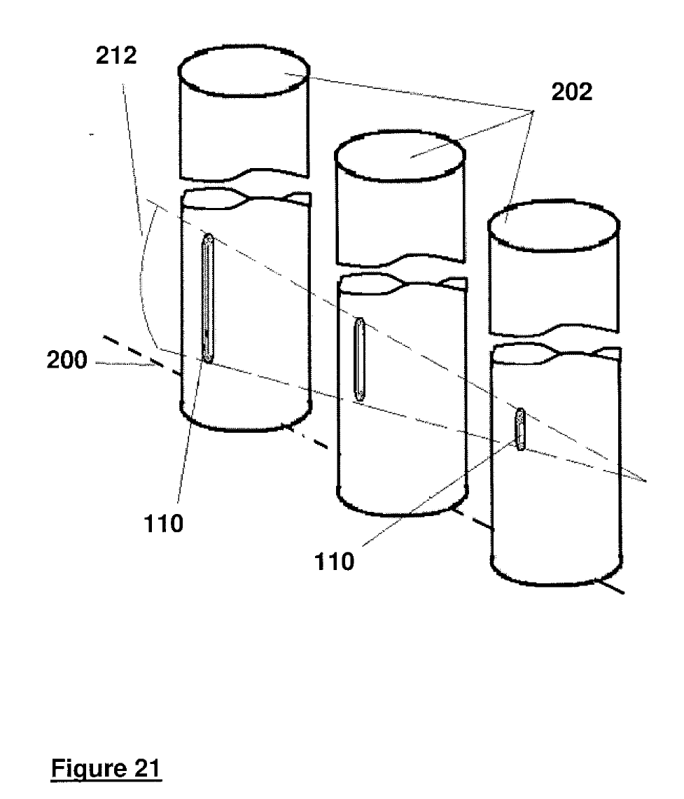

A typical array 202 may further enable visual perspective effects, as seen in FIG. 21, by varying the size of visual element 110 according to a scheme that forms a vertical distribution of lines of sight (LOS) 210, which may be used to create various depth illusions and cognitive effects in the mind of the onlookers. Alternatively, physical message section 108 may be three-dimensional and placed on either a flat or a concave module 100 for similar effects. This option also allows three-dimensional elements such as pipes filled with air, gas, fluid, foam, or solid material to be used for the same end.

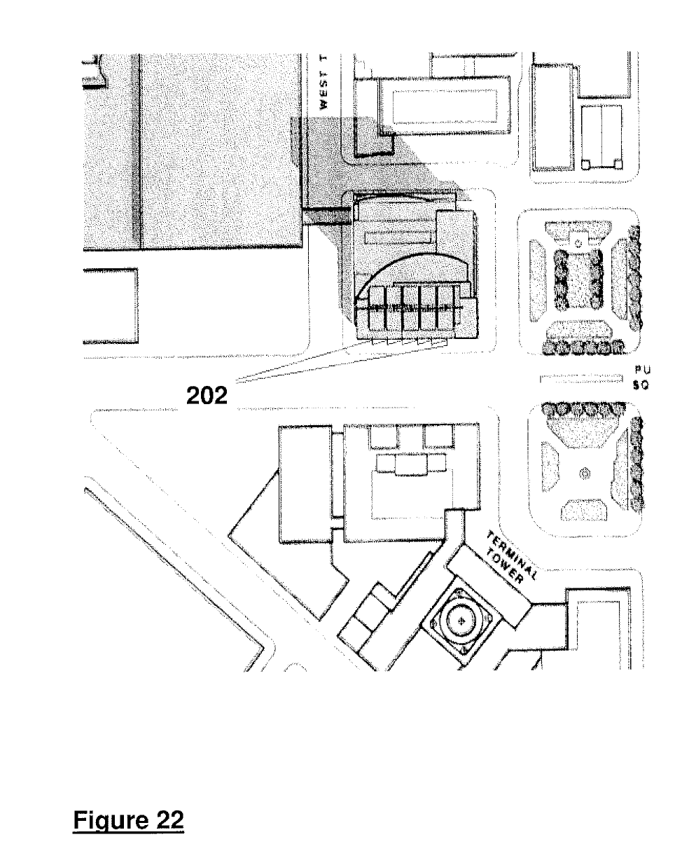

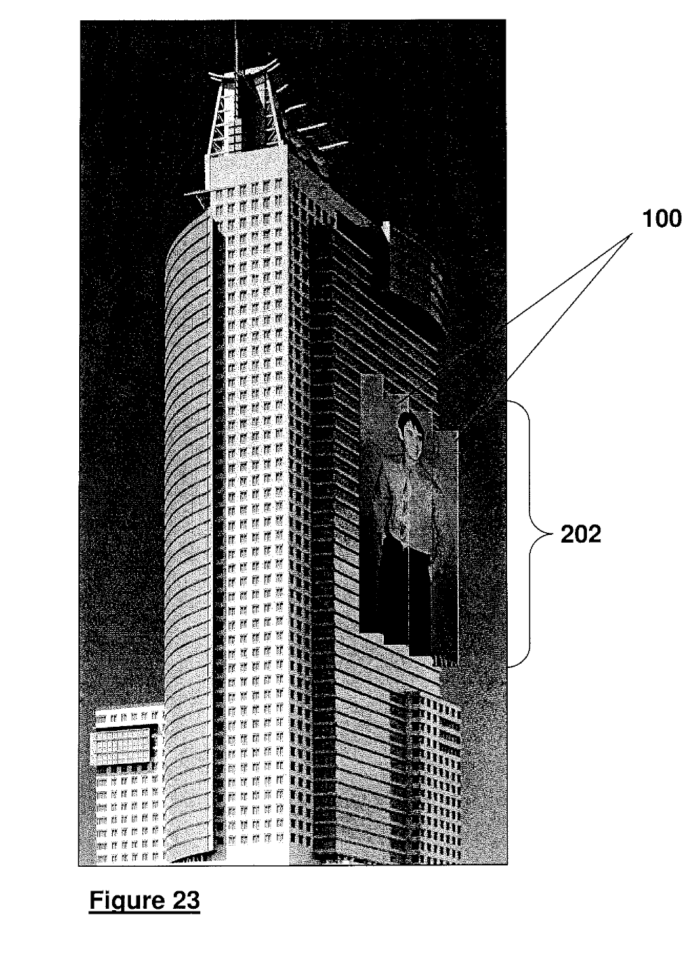

Another alternative for displaying a typical array 202 is to mount array 202 in a public passageway such as a long corridor, sidewalk, building side, along a bridge span, down the length of an aisle, and other similar locations. FIG. 22 describes a plan view of a city street, where a typical array 202 of modules 100 is mounted, according to this alternative, on the outer wall of a public building. Unified message 208 that results from an array 202 mounted in this fashion is seen in FIG. 23.

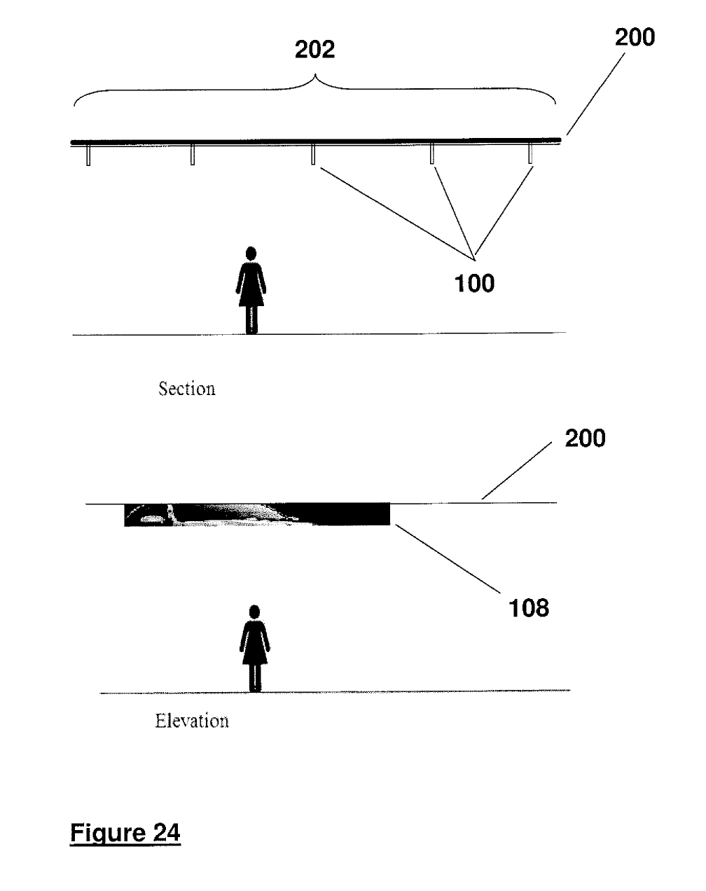

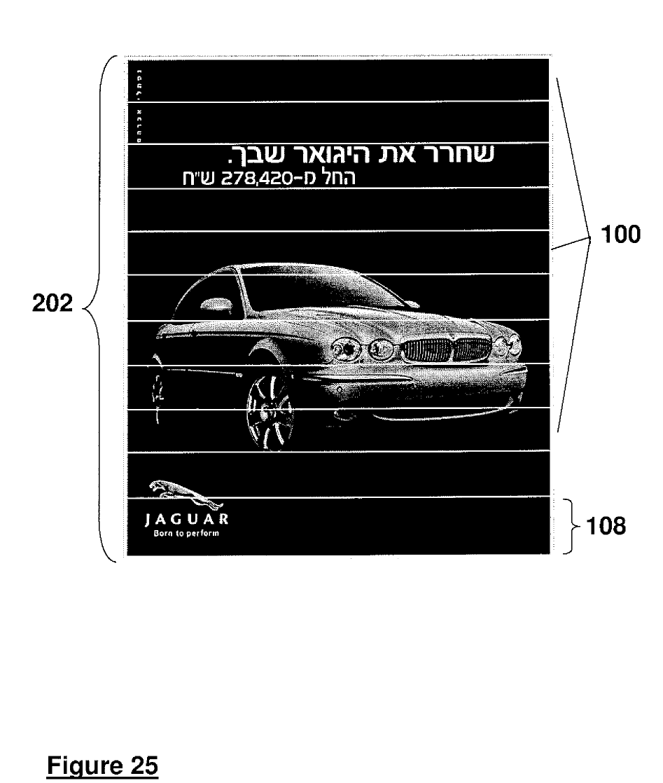

Yet another alternative location for displaying an array 202 is on the ceiling or floor of an interior or exterior location. FIG. 24 describes both a sectional and an elevation view of an array 202 of modules 100 according to this alternative where array 202 is mounted on the ceiling of a long corridor in a building. FIG. 25 shows the resulting view of this array 202 of modules 100.

Yet another option is to integrate subliminal messages, whereby either a single or multiple physical message sections 108 in the form of one or multiple subliminal messages are inserted within an array 202, or a where a single or several visual elements 110 in the form of a subliminal message are inserted in one or more modules 100 within an array 202.

A further option of this system is that individual modules 100 within array 202 can be electronically controlled in order to create the impression that visual element 110 is moving with the passerby. This can be accomplished by creating a chase effect, whereby visual element 110 on modules 100 automatically turn on and off in sequence. The frequency of the sequencing may be predetermined, according to the average speed of the traffic, or according to the speed of a specific vehicle. The formula for determining said frequency is F=V/D, wherein “F” represents frequency, “V” represents velocity, and “D” represents the displacement between two modules 100. When visual element 110 is moving at a fixed speed, this movement may become a safety feature, whereby, for example, the driver receives visual confirmation of compliance with a posted speed limit.

According to a further embodiment option, visual element 110 is repeated or is switched ON and OFF at a frequency that corresponds to a certain speed of the passing traffic and is determined according to the same formula of F=V/D. Thus, unified image 208 has the effect of signaling to the driver that his speed is or is not within an acceptable range. Such a feature may be further used to alert or to issue strong warnings to speeding drivers.

There further exists the option of limiting the viewable angle of modules 100 by affixing blinders to the sides of modules 100, causing modules 100 to be visible only when the passerby views modules 100 from a relatively narrow angle range. This can be a useful safety feature because of the decreased distraction to the drivers.

Where modules 100 are placed in the center of the road or along the median strip between multiple lanes of traffic, modules 100 can be two-sided, allowing the same or different unified messages 208 to be put across to drivers traveling in different directions.

Furthermore, strategically placing modules 100 can reduce driver risk and enhance the comfort of occupants of buildings along the street. An array 202 may be placed such that modules 100 provide an additional safety benefit to drivers by blocking the glare from the headlights of oncoming traffic. Additionally, modules 100 may be positioned so as to prevent the beams of vehicle headlights from passing through windows of roadside buildings such as houses, offices or the like, thus reducing the disturbance to the occupants of the buildings. Modules 100 may further serve as a potential sound barrier by being made able to absorb sound pressure energy in order to reduce the levels of exposure of both occupants of roadside buildings and passersby to the noise created by passing traffic.

In any of the embodiments, all components of the information and safety system may be made of any possible material, including resilient materials of a flexible nature in order to withstand severe windy weather conditions or accidental impacts.

While the above description contains many specifics, these should not be construed as limitations on the scope of the invention, but rather as exemplifications of the preferred embodiments. Those skilled in the art will envision other possible variations that are within the scope of the invention. Accordingly, the scope of the invention should be determined not by the embodiment illustrated, but by the appended claims and their legal equivalents.

What is claimed is:

1. A system for displaying visual messages to be viewed from a designated viewing area, said viewing area including at least one designated viewing point, said system comprised of
i. at least two display modules of calculated size, positioned at calculated distances from each other and at calculated angles, in accordance with a predefined placement pattern, each module carrying at least one message section of calculated size being a portion of a unified message, wherein the cognitive combination of the physical message sections creates the perception of a large and clear visual unified message when viewed from the designated viewing area.

2. The system of claim 1 wherein at least one of the following parameters has variable value: the modules size, message section size, the distance between the modules or the module placement angles.

3. The system according to claim 1 wherein the predetermined placing pattern is a straight placement line at a relative angle to the viewing area.

4. The system according to claim 1 wherein the placement angle of at least several of physical message sections is constant.

5. The system according to claim 1 wherein the angles are defined by positioning the modules at approximately right vertical angles (90°) to the line of sight of onlookers positioned in a designated viewing area.

6. The system of claim 1 wherein the predefined placement pattern is designed so that when viewed from anywhere other than the designated viewing points, the modules cause minimal obstruction to viewing the surrounding scenery.

7. The system of claim 1 wherein the modules are positioned along a curved placement line.

8. The system according to claim 1 wherein the size of at least several of physical message sections or of the modules is constant.

9. The system according to claim 1 wherein size of at least one module is designed to fit a full letter of text on a physical message section placed on the said module.

10. The system according to claim 1 where at least one physical message section or module is extended to include, in addition to its original part of the visual message, a repetition of a part of the visual message that appears on an adjacent module.

11. The system of claim 1, wherein the modules are located behind each other at a relatively close distance and at least a portion of at least one module or physical message section is designed to be transparent so that the overlapping combination of the transparent physical message section with a visual element of another section creates the effect of one clear unified message when viewed from the designated viewing points.

12. The system of claim 1 wherein the geometric shape of the module or physical message section is not symmetric.

13. The system of claim 11 wherein the relative geometric proportions between the various parts of the module or physical message section are designed so that when viewed from a short distance, the unified message is perceived as being essentially straight and when viewed from a long distance, the unified message is perceived as being distorted.

14. The system of claim 11 wherein the geometrical shape of the modules or physical message sections are designed so as to create a continuous circumferential shape for the unified message when viewed from the designated viewing area.

15. The system according to claim 1 wherein the display modules are mounted on the walls, floors, or ceilings of buildings, including interior and exterior spaces of a building.

16. The system according to claim 1 wherein at least one message section or visual element on at least one module is of a different size, enabling the creation of perspective illusion.

17. A system according to claim 1 that utilizes panels as display modules, wherein said panels, formed as shutter blades, are positioned and spaced apart end to end, along the length of a road.

18. A system according to claim 1, in which said display modules are made of a material that absorbs light energy to eliminate glare.

19. The system of claim 1, in which the physical message section enables the mechanical or manual changing of at least one visual element.

20. The system of claim 1, in which the modules are formed so as to include a dynamic physical message section that can be altered electronically.

21. The system of claim 1, in which the unified message conveys at least one of the following: road related information, or commercial information.

22. The system of claim 1, further having a mounting device for connecting the display modules to a road part at different angles.

23. The system of claim 1 having at least one attachment device to enable attaching physical message sections to the display modules.

24. The system of claim 1 in which at least one display module is equipped with at least one lighting element.

25. The system of claim 1 in which at least one display module is equipped with at least one sensor for measuring at least one road traffic parameter.

26. The system of claim 24 further having at least one data transmission device that is able to transmit said sensor measurements to bypassing vehicles or to a remote terminal.

27. The system of claim 1 in which at least one display module has at least two faces, each module face addressing at least one direction.

28. The system of claim 26 wherein each module face displays a part of a different unified message.

29. The system of claim 1 in which said display modules further include at least one pressure energy absorbing element for absorbing and reducing road noise.

30. The system of claim 23 in which the lighting element is a passive device, selected from having a distinct color or from being energized by light from passing vehicles.

31. The system of claim 23 in which the lighting element is an active device, energized by a power source from natural energy sources.

32. The system of claim 1 wherein the relative distance between at least several adjacent physical message sections or modules is constant.

33. The system of claim 23 in which the lighting element signals to the vehicle once the vehicle reaches a predefined proximity to a predefined location on the road.

34. The system of claim 23 in which the lighting element has distinct colors to advise the passing driver of road boundary types or road conditions or to denote the left and right sides of the road boundary to the passing driver.

35. The system of claim 1 in which at least one visual element includes distinct colors to advise the passing driver of road boundary types or road conditions or to denote the left and right sides of the road boundary to the passing driver.

36. The system of claim 1 in which at least two visual elements are present and vertically spaced, denoting to the passing driver the depth of the road covered by water or snow.

37. The system of claim 1 in which at least one visual element is repeated over multiple modules in a pseudo-random manner.

38. The system of claim 1 in which at least one visual element is repeated over multiple modules in a manner that creates the appearance of an animated unified message.

39. The system of claim 1 wherein the individual modules can be electronically controlled to display, or hide, a visual element at a specific frequency in order to create the impression that the visual element is moving across the array at a specific speed.

40. The system of claim 39 wherein said speed is a traffic related speed selected from the speed of at least one vehicle and the average speed of the traffic moving alongside the modules.

41. The system of claim 39 further including a sensor for measuring vehicle speed, wherein said speed is the speed of at least one vehicle moving alongside the modules.

42. The system of claim 1 wherein the distances and angles of the predetermined placement pattern of the display modules or physical message sections and their sizes are calculated in accordance with an algorithm based on mathematical formulae that define the geometric relationship between the designated viewing point locations and the placement of the display modules.

43. The system of claim 1 wherein the display modules are designed to be at least partially made of flexible parts.

44. The system of claim 1 wherein the display module or physical message section is designed and constructed as a slender, elongate panel body.

45. The system of claim 1 wherein the display module or physical message section or visual element is designed and constructed as a volumetric, three-dimensional body.

46. The system of claim 1 wherein the physical message section of the display module creates a three-dimensional visual effect.

47. The system of claim 1 further including blinders attached to the sides of the display module so as to limit the range of viewing angles.

48. The system of claim 1 wherein a single visual element in the form of a subliminal message is inserted within an array of physical message sections.

49. The system of claim 1 wherein at least one visual element is distorted, and where the distortion is calculated in accordance with an algorithm based on mathematical formulas that define the differential perceived distortion created by the distortion of each part of the unified message.

50. A method for displaying visual messages to be viewed from a designated viewing area, said viewing area including at least one designated viewing point, said method comprising the steps of:
positioning at least two display modules of variable size, at variable distances from each other and at variable angles, in accordance with a placement pattern, each module carrying at least one physical message section of a unified message, wherein the cognitive combination of the physical message sections creates the perception of a large and clear visual unified message when viewed from the designated viewing area.

51. The method of claim 49 further comprising the step of calculating the distances and angles of the predetermined placement pattern of modules or physical message sections and their sizes in accordance with an algorithm based on mathematical formulae that define the geometric relationship between the designated viewing point location and the placement of the visual elements of the unified message.

52. The method of claim 49 further comprising the step of dynamically moving or rotating at least one visual element.

53. The method of claim 49 further comprising the step of dynamically changing the physical dimensions of the module or the message section or the visual element.

54. The method of claim 49 further comprising the step of dynamically changing the positioning of at least one module or message section or visual element.
